(19) United States
(12) Patent Application Publication
(10) Pub. No.: US 2008/0008441 A1
(43) Pub. Date: Jan. 10, 2008

(54) Recording and reproducing apparatus having video editing function

(75) Inventor: Naofusa Higashide, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/822,008

(22) Filed: Jun. 29, 2007

(30) Foreign Application Priority Data
Jun. 30, 2006 (JP) 2006-181074

(51) Int. Cl. H04N 5/93

(52) U.S. Cl. 386/52

(57) ABSTRACT

The invention provides a recording and reproducing apparatus capable of facilitating understanding of the edited portion. If a user wishes to delete a portion of data in a file recording video and audio data, a start point and an end point of the area to be deleted are designated to determine the delete area. In order to confirm the delete editing process, the video to be deleted is displayed as monochrome image when reproducing the file in a temporarily edited state, so that the user can easily understand that the portion of the data is designated to be deleted.

The present application is based on and claims priority of Japanese patent application No. 2006-181074 filed on Jun. 30, 2006, the entire contents of which are hereby incorporated by reference.

### BACKGROUND OF THE INVENTION

1. Field of the Invention

The present invention relates to a recording and reproducing apparatus having a video editing function that facilitates visual understanding of a video editing operation.

2. Description of the Related Art

Conventionally, various methods have been disclosed to enable the user to arbitrarily edit video and audio data recorded in a recording medium. For example, Japanese Patent Application Laid-Open Publication No. 10-248048 (patent document 1) discloses a method for editing video data stored in a recording medium such as a tape, comprising storing the video data temporarily in a storage means for operation, editing the video stored in the storage means for operation, storing the edited contents as editing list, and reproducing the video as preview based on the editing list.

Further, Japanese Patent Application Laid-Open Publication No. 2002-84495 (patent document 2) discloses a method for storing the positional information edited by the user, reproducing sections of the data divided by the positional information, and using the sections as the objects of re-editing operation. According to the disclosure of patent document 2, it is possible to simultaneously create and display thumbnail images corresponding to sections, display the reproducing time of each section, display a maximum of nine sections as thumbnail images on a single screen, and select the image to be edited.

However, according to the method disclosed in patent document 1, though it is possible to confirm the edited video via preview, the user must remember the edited position in order to understand which portion of the video was edited, and it is difficult to confirm the edited position. Even according to the method disclosed in patent document 2, it is possible to check the video in finer units via thumbnail images corresponding to each specific sections of the video, but it is difficult to clearly understand the edited position of the edited video.

### SUMMARY OF THE INVENTION

The present invention aims at solving the problems mentioned above, by providing a recording and reproducing apparatus having a video editing function enabling the user to clearly understand the edited portions.

A recording and reproducing apparatus having a video editing function according to a first aspect of the present invention comprises a recording and reproducing means for recording and reproducing data on a recording medium; an encoding means for encoding video and audio data when recording the same to the recording medium; a decoding means for decoding video and audio data stored in the recording medium for reproduction; and a control means for processing the video and audio data decoded via the decoding means so as to enable editing of the video and audio data and also reproducing the video and audio data during editing operation in a temporarily edited state; wherein the recording and reproducing apparatus further comprises a special video effect processing means capable of reproducing the audio and video data in the temporarily edited state so as to enable the editing result to be confirmed during the editing process, and upon reproducing the audio and video data in the temporarily edited state, providing a special video effect when the video being reproduced enters the edited portion.

According to the arrangement of the first aspect of the invention, the recording and reproducing apparatus having a video editing function according to the present invention provides a special video effect to the portion of the video and audio data having been edited when reproducing the edited video and audio data as temporarily edited data.

The recording and reproducing apparatus having a video editing function according to aspect 2 of the present invention relates to the recording and reproducing apparatus according to aspect 1, wherein when editing is performed to partially delete the video and audio data, the special video effect processing means provides a special video effect to the video data portion designated to be deleted upon reproducing the data in the temporarily edited state.

According to the arrangement of aspect 2, when editing is performed to delete video and audio data, a special video effect is provided to the area of the video and audio data to be deleted upon reproducing the video in a temporarily edited state, before actually deleting the data.

The recording and reproducing apparatus having a video editing function according to aspect 3 of the present invention relates to the recording and reproducing apparatus according to aspects 1 or 2, wherein when editing is performed to merge two video and audio data, the special video effect processing means provides a special video effect to the video data portion positioned posteriorly in a time axis of the two video and audio data designated to be merged upon reproducing the data in the temporarily edited state.

According to the arrangement of aspect 3, when editing is performed to merge two video and audio data, a special video effect is provided to the video positioned posteriorly in a time axis of the two video and audio data designated to be merged upon reproducing the data in the temporarily edited state, before actually merging the data.

The recording and reproducing apparatus having a video editing function according to aspect 4 of the present invention relates to the recording and reproducing apparatus according to any one of aspects 1 through 3, wherein when editing is performed to divide a single video and audio data, the special video effect processing means provides a special video effect to the video data portion positioned posteriorly in a time axis from the dividing point designated in the video and audio data upon reproducing the data in the temporarily edited state.

According to the arrangement of aspect 4, when editing is performed to divide the video and audio data, a special video effect is provided to the video following the dividing point upon reproducing the data in the temporarily edited state as video and audio data having the point of division set thereto, before actually dividing the data.

The recording and reproducing apparatus having a video editing function according to aspect 5 of the present invention relates to the recording and reproducing apparatus according to any one of aspects 1 through 4, wherein the special video effect processing means provides a color effect to the whole video upon reproducing the portion of the video being subjected to editing operation.

According to the arrangement of aspect 5, when partially deleting a video data, merging two video data or dividing a video data, a color effect such as change of color tone or contrast of the video image is provided to the portion being the object of editing operation upon temporarily reproducing the video for confirming the edited contents.

The recording and reproducing apparatus having a video editing function according to aspect 6 of the present invention relates to the recording and reproducing apparatus according to any one of aspects 1 through 4, wherein the special video effect processing means performs an OSD display showing the editing method performed to a corresponding portion upon reproducing the portion of the video being subjected to editing operation.

According to the arrangement of aspect 6, when partially deleting a video data, merging two video data or dividing a video data, an OSD display showing what type of editing operation had been performed is displayed to the portion being subjected to editing operation upon temporarily reproducing the video for confirming the edited contents.

### BRIEF DESCRIPTION OF THE DRAWINGS

FIG. 1 is a block diagram showing the configuration of a recording and reproducing apparatus according to a preferred embodiment of the present invention;

FIG. 2 is a flowchart showing the operation of a recording and reproducing apparatus during editing of video according to the same;

FIG. 3 is an explanatory view showing the method for partially deleting a file in the recording and reproducing apparatus according to the same;

FIG. 4 is an explanatory view showing the method for merging two files in the recording and reproducing apparatus according to the same; and

FIG. 5 is an explanatory view showing the method for dividing a file in the recording and reproducing apparatus according to the same.

### DETAILED DESCRIPTION OF THE PREFERRED EMBODIMENTS

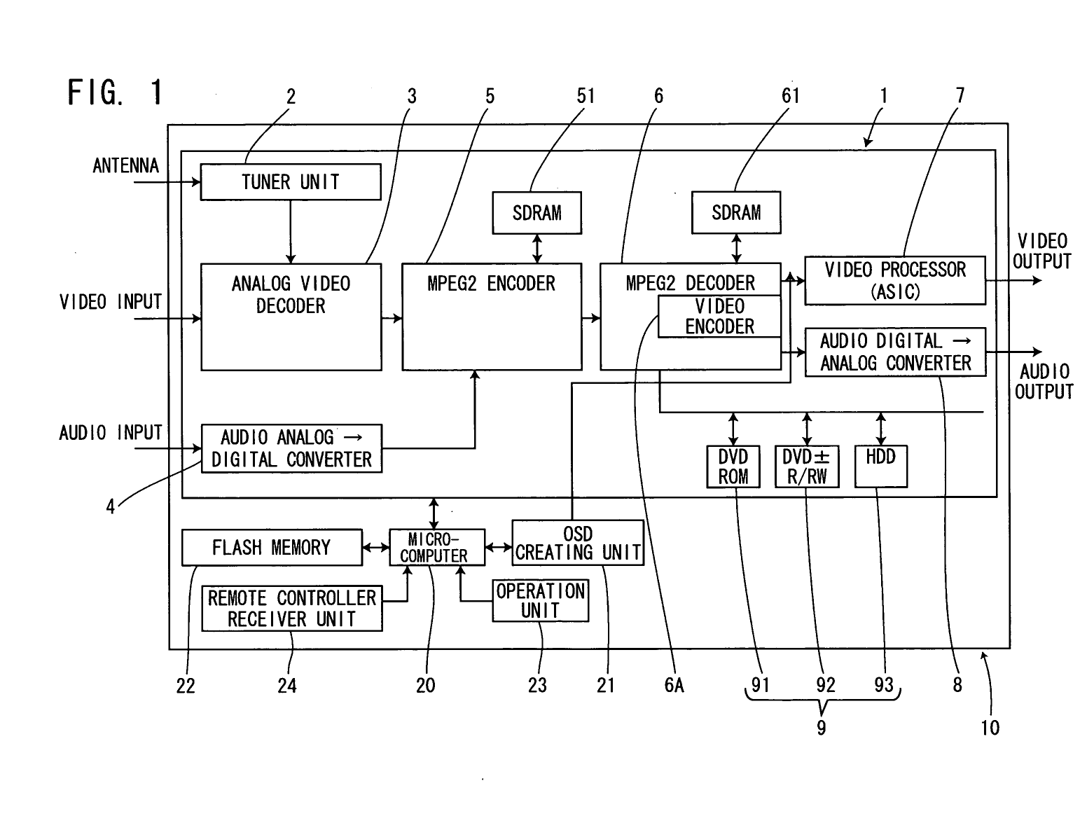

Now, the preferred embodiment for carrying out the present invention will be described with reference to FIGS. 1 through 5. Of course, the present invention is applicable to examples other than that disclosed in the embodiment within the scope of the present invention.

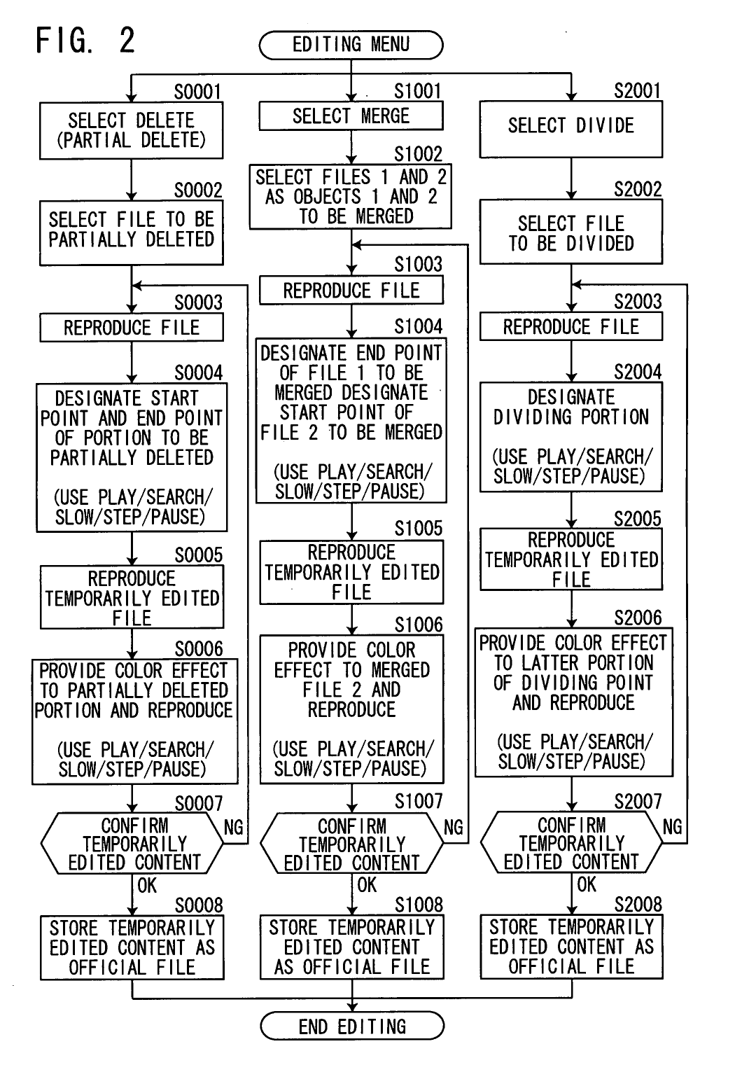

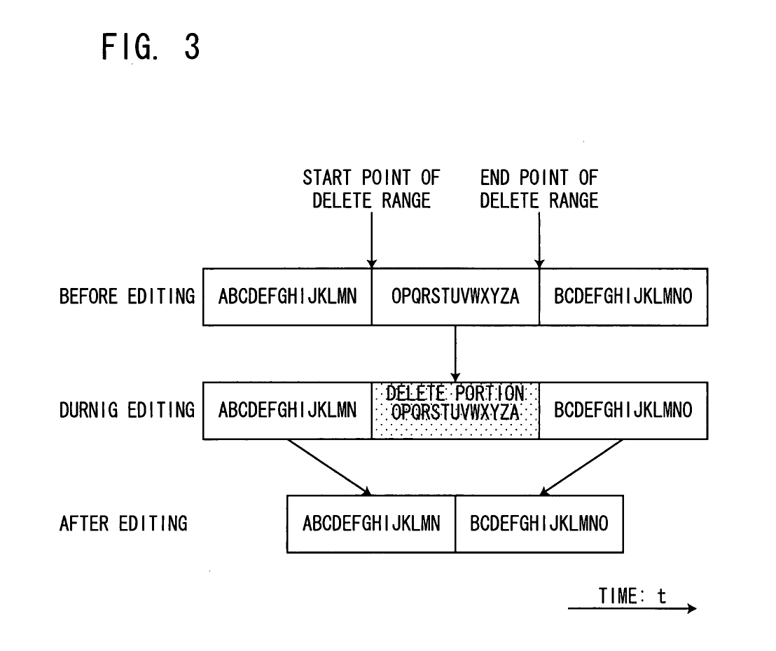

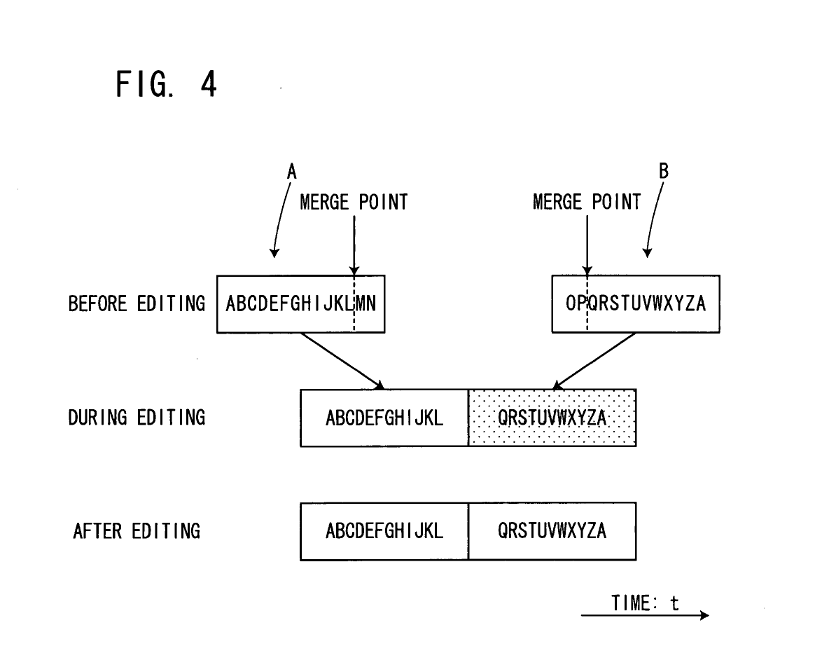

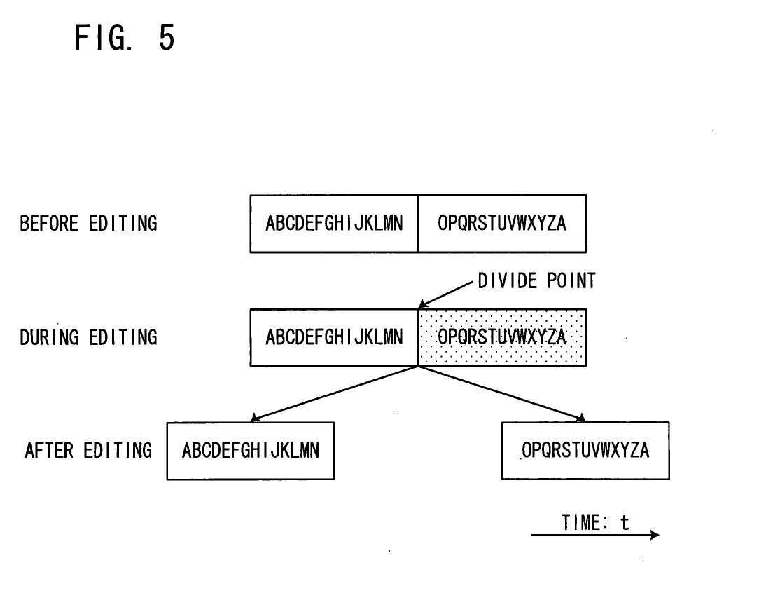

FIGS. 1 through 5 illustrate a preferred embodiment of the present invention, wherein FIG. 1 is a block diagram showing a recording and reproducing apparatus according to the present embodiment. FIG. 2 is a flowchart showing the operation for performing editing according to the recording and reproducing apparatus. FIG. 3 is an explanatory view showing the method for deleting a portion of data from the video and audio data. FIG. 4 is an explanatory view showing a method for merging two video and audio data. FIG. 5 is an explanatory view showing a method for dividing the video and audio data.

The arrangement of the recording and reproducing apparatus according to the present embodiment will be described with reference to FIG. 1. Reference number 10 is a recording and reproducing apparatus having a video editing function. Reference number 1 denotes a signal processing unit composed of members listed hereafter. Reference number 2 denotes a tuner unit for receiving broadcast signals input from an antenna or the like. Reference number 3 is an analog video decoder for converting analog video signals input from the tuner unit 2 or an external device to digital data. Reference number 4 denotes an audio analog digital converter (hereinafter referred to as audio A/D converter) for converting analog audio signals input from an external device to digital data. Reference number 5 is an MPEG2 encoder which is an encoding means for encoding the video signals obtained from the analog video decoder 3 and audio data obtained from the audio A/D converter 4 into MPEG2 data. Reference number 51 denotes an SDRAM which is a temporary storage region used for encoding the video and audio data via the MPEG2 encoder. Reference number 6 denotes an MPEG2 decoder for decoding the video and audio data encoded via the MPEG2 encoder 5 to reproduce the same. Reference number 61 denotes a flash memory used for loading a program and the like in the MPEG2 decoder 6. Reference number 6A denotes a video encoder for converting the video and audio data encoded into digital data to analog data for reproducing the same via an output device. Reference number 7 denotes a video processor which is a special video effect processing means for providing a special video effect to the video data decoded via the MPEG2 decoder 6 and converted into analog data via the video encoder 6A. Reference number 8 denotes an audio digital analog converter (hereinafter referred to as audio D/A converter) for converting the audio data decoded via the MPEG2 decoder 6 to analog data for outputting the same. Reference number 9 denotes a recording medium as recording and reproducing means, which utilizes, for example, a DVD-ROM 91 which is a read-only medium, a DVD+-R or DVD+-RW 92 which are readable and writable media, and a HDD 93 which is an installation-type recording medium.

Reference number 20 denotes a microcomputer as control means for editing the video and audio data and reproducing the data subjected to editing as temporarily edited data, and controlling the operation of the whole apparatus including a signal processing unit 1 via operation from a menu screen or the like. Reference number 21 denotes an OSD display unit for creating an OSD for displaying various information of the apparatus such as the menu screen mentioned above and other operation screens. Reference number 22 denotes a flash memory for storing necessary information during operation of the microcomputer 20. Reference number 23 is an operation unit such as keys disposed on the apparatus, and reference number 24 denotes a remote controller, which are both used for operating the recording and reproducing apparatus 1.

The operation during editing operation of the recording and reproducing apparatus 10 will be described with reference to FIGS. 2 through 5. First, the operation accompanying partially deleting a file which contains video and audio data will be described. At first, DELETE is selected in an edit menu screen or the like (S0001). Then, the file to be subjected to delete operation is selected (S0002). The selected file is reproduced (S0003). As illustrated in “before editing” of FIG. 3, the start point and end point of the portion desired to be deleted is designated via the operation unit 23 or the remote controller 24 (S0004). The file being in a temporarily edited state having designated the portion to be deleted is then reproduced (S0005). As shown in “during editing” of FIG. 3, the whole video data of the portion to be deleted designated in step S0004 (portion shown by tone in the drawing) is reproduced as monochrome video which is a special video effect (S0006). A message is displayed to confirm the user whether the temporarily edited contents is ok or not (S0007), and if it is ok, as shown in “after editing” of FIG. 3, the data is stored as a file having merged the respective merge points (S0008).

Next, the operation accompanying merging of two files will be described. For convenience, the two files are called file A and file B, and it is assumed that the merge is performed so that file A constitutes the front half and file B constitutes the rear half in the time axis. At first, MERGE is selected in the editing menu screen or the like (S1001). Then, the two files to be merged are selected (S1002). File A is reproduced (S1003). As shown in “before editing” of FIG. 4, the operation unit 23 or the remote controller 24 is used to designate a merge point as the end point of edited file A. After designating the same, the reproduction of file B is started, and a merge point as the start point of edited file B is designated (S1004). The file being in a temporarily edited state with the merge points designated is reproduced (S1005). As shown in “during editing” of FIG. 4, when the data being reproduced reaches the merge point designated in file A, the reproduction of file A is stopped, and file B is reproduced from the designated merge point (portion shown by tone in the drawing) as monochrome video (S1006). A message is displayed to confirm the user whether the temporarily edited content is ok or not (S1007), and if it is ok, the file is stored as a file merging file A and file B via respectively designated merge points, as shown in “after editing” of FIG. 4 (S1008).

Next, the operation accompanying dividing of files will be described. DIVIDE is selected in the editing menu screen (S2001). The file to be divided is selected (S2002). The reproduction of the selected file is started (S2003). As shown in “before editing” of FIG. 5, a desired dividing point in the file being reproduced is designated via the operation unit 23 or the remote controller 24 (S2004). The file having the dividing point designated is reproduced as temporarily edited state (S2005). As shown in “during editing” of FIG. 5, the portion positioned rearward in the time axis from the designated dividing point (portion shown by tone in the drawing) is reproduced as monochrome video (S2006). A message is displayed to confirm the user whether the temporarily edited content is ok or not (S2007), and if it is ok, the file is divided into two at the dividing point, as shown in “after editing” of FIG. 5, and the divided files are stored respectively (S2008).

According to the recording and reproducing apparatus being arranged as above, when an editing operation is performed to delete, merge or divide video and audio data files stored in a recording medium, a special video effect or color effect is provided to the video being edited to be deleted, merged or divided, so that it becomes possible to clearly understand which portion of the video is subjected to editing. Moreover, since the video is reproduced as monochrome video, the user can understand where the edited portion of the video is started during reproduction of data regardless of where in the screen the user is watching.

The recording and reproducing apparatus according to the present embodiment has been described in detail, but the present invention is not restricted to the above embodiment, and various modifications are possible within the scope of the present invention. For example, the special video effect according to the present embodiment is a monochrome video, but it is not restricted thereto, and for example, it is possible to provide a color effect to change the whole video to a color tone different from normal reproduction, such as sepia. Moreover, it is possible to notify the user that a specific portion of the video is subjected to editing operation by performing the special video effect process via the microcomputer 20 or the OSD creating unit 21, and to provide an OSD display denoting “delete”, “merge”, “divide” and the like instead of providing a color effect. Furthermore, the processing of a special video effect is performed according to the present embodiment via a video processor, but is not restricted thereto, and it is also possible to add a function to provide special video effect process via the MPEG2 decoder.

The effects of the present invention are as follows.

According to the first aspect of the present invention, the recording and reproducing apparatus having a video editing function comprises a recording and reproducing means for recording and reproducing data on a recording medium; an encoding means for encoding video and audio data when recording the same to the recording medium; a decoding means for decoding the video and audio data stored in the recording medium for reproduction; and a control means for processing the video and audio data decoded via the decoding means so as to enable editing of the video and audio data and also reproducing the video and audio data during editing operation in a temporarily edited state; wherein the recording and reproducing apparatus further comprises a video editing function having a special video effect processing means capable of reproducing the audio and video data in the temporarily edited state so as to enable the editing result to be confirmed during the editing process, and upon reproducing the audio and video data in the temporarily edited state, performing reproduction with a special video effect when the video being reproduced enters the edited portion; therefore, by providing a special video effect to the object being edited during reproduction of the video being edited in a temporarily edited state for confirmation, the user can easily determine which portion of the video has been subjected to editing operation regardless of where in the screen the user is watching.

According to the second aspect of the present invention, the recording and reproducing apparatus having a video editing function according to aspect 1 further characterizes in that when editing is performed to partially delete the video and audio data, the special video effect processing means provides a special video effect to the video and audio data portion designated to be deleted upon reproducing the data in the temporarily edited state; therefore, when the video and audio data is reproduced in the temporarily edited state to confirm the portion to be deleted, a special video effect is provided to the video when reproducing the video and audio data being the object of deleting operation, so that the user can easily understand the portion of the video to be deleted.

According to the third aspect of the present invention, the recording and reproducing apparatus having a video editing function according to aspect 1 or aspect 2 further characterizes in that when editing is performed to merge two video and audio data, the special video effect processing means provides a special video effect to the video and audio data portion positioned posteriorly in a time axis of the two video and audio data designated to be merged upon reproducing the data in the temporarily edited state; therefore, when two video and audio data are merged and the merged video and audio data are reproduced in the temporarily edited state, the data positioned posteriorly in the time axis of the two merged data is subjected to special video effect during reproduction of the merged video and audio data, so that the user can easily understand the point in which the video data are merged.

According to the fourth aspect of the present invention, the recording and reproducing apparatus having a video editing function according to aspects 1 through 3 further characterizes in that when editing is performed to divide a single video and audio data, the special video effect processing means provides a special video effect to the video and audio data portion positioned posteriorly in a time axis from the dividing point designated in the video and audio data upon reproducing the data in the temporarily edited state; therefore, when dividing video and audio data, a special video effect is provided to the reproduced video of the data positioned posteriorly in a time axis from the dividing point upon reproducing the video and audio data in the temporarily edited state having designated the dividing point, and the user can easily understand the point at which the video is to be divided.

According to the fifth aspect of the present invention, the recording and reproducing apparatus having a video editing function according to any one of aspects 1 through 4 further characterizes in that the special video effect processing means provides a color effect to the whole video upon reproducing the portion of the video being subjected to editing operation; therefore, a color effect is provided to the whole screen when temporarily reproducing the edited video for confirmation, and the user can easily understand the portion being edited regardless of the area of the screen that the user is watching.

According to the sixth aspect of the present invention, the recording and reproducing apparatus having a video editing function according to any one of aspects 1 through 4 further characterizes in that the special video effect processing means performs an OSD display showing the editing method performed to a corresponding portion upon reproducing the portion of the video being subjected to editing operation; therefore, an OSD display notifying the editing method is displayed when temporarily reproducing the edited video for confirmation, and the user can easily understand how the edited portions are edited.

1. A recording and reproducing apparatus having a video editing function, comprising:
a recording and reproducing means for recording and reproducing data on a recording medium;
an encoding means for encoding video and audio data when recording the same to the recording medium;
a decoding means for decoding the video and audio data stored in the recording medium for reproduction; and
a control means for processing the video and audio data decoded via the decoding means so as to enable editing of the video and audio data and also reproducing the video and audio data during editing operation in a temporarily edited state;
wherein the recording and reproducing apparatus further comprises a video editing function having a special video effect processing means capable of reproducing the audio and video data in the temporarily edited state so as to enable the editing result to be confirmed during the editing process, and upon reproducing the video and audio data in the temporarily edited state, providing a special video effect when the video being reproduced enters the edited portion.

2. The recording and reproducing apparatus having a video editing function according to claim 1, wherein
when editing is performed to partially delete the video and audio data, the special video effect processing means provides a special video effect to the video data portion designated to be deleted upon reproducing the data in the temporarily edited state.

3. The recording and reproducing apparatus having a video editing function according to claim 1 or claim 2, wherein
when editing is performed to merge two video and audio data, the special video effect processing means provides a special video effect to the video data portion positioned posteriorly in a time axis of the two video and audio data designated to be merged upon reproducing the data in the temporarily edited state.

4. The recording and reproducing apparatus having a video editing function according to claim 1 or claim 2, wherein
when editing is performed to divide a single video and audio data, the special video effect processing means provides a special video effect to the video data portion positioned posteriorly in a time axis from the dividing point designated in the video and audio data upon reproducing the data in the temporarily edited state.

5. The recording and reproducing apparatus having a video editing function according to claim 1 or claim 2, wherein the special video effect processing means provides a color effect to the whole video upon reproducing the portion of the video being subjected to editing operation.

6. The recording and reproducing apparatus having a video editing function according to claim 1 or claim 2, wherein the special video effect processing means performs an OSD display showing the editing method performed to a corresponding portion upon reproducing the portion of the video being subjected to editing operation.
